(19) United States
(12) Patent Application Publication
(10) Pub. No.: US 2018/0017901 A1
(43) Pub. Date: Jan. 18, 2018

(54) MEDIUM TRANSPORT APPARATUS AND IMAGE FORMING APPARATUS

(71) Applicant: Oki Data Corporation, Tokyo (JP)

(72) Inventor: Naoki KANZAWA, Tokyo (JP)

(21) Appl. No.: 15/647,530

(22) Filed: Jul. 12, 2017

(30) Foreign Application Priority Data
Jul. 15, 2016 (JP) 2016-140095

(51) Int. Cl. G03G 15/16; G03G 15/02

(52) U.S. Cl. CPC G03G 15/162; G03G 15/161; G03G 15/0216; G03G 2215/1685

(57) ABSTRACT

A medium transport apparatus includes a transport section that transports a medium so that a widthwise direction of the medium is directed to a predetermined direction, and a contact roller that contacts the medium transported by the transport section. An axial direction of the contact roller is inclined with respect to the predetermined direction. A flange is disposed at a side of the contact roller in the axial direction. The flange has a surface defining a position of the medium. The surface is perpendicular to the predetermined direction.

### BACKGROUND OF THE INVENTION

The present invention relates to a medium transport apparatus configured to transport a medium, and an image forming apparatus including the medium transport apparatus.

An image forming apparatus such as a printer is configured to transport a medium and form an image on the medium. If skew or meandering of the medium occurs, a displacement of an image or a jam of the medium may occur.

In the case where the medium is a cut sheet, the skew and meandering of the medium can be effectively suppressed by abutting a leading end of the medium against a nip between two rollers (i.e., registration rollers). However, in the case where the medium is a rolled sheet or the like (i.e., a continuous medium), it is difficult to sufficiently suppress the skew and meandering, since such a medium has only one leading end.

Therefore, in order to suppress skew and meandering of a medium such as a rolled sheet, it has been proposed to provide a flange or the like contacting a side end of a medium in a widthwise direction. More specifically, Japanese Utility Model Application Publication S59-68744 (FIG. 4) discloses a flange provided at an end of a tapered roller in an axial direction. The tapered roller causes the medium to move in the widthwise direction and contact the flange.

However, in the above described configuration, the side end of the medium is pressed against the flange, and causes friction. Therefore, in the case where the medium (for example, a thin sheet) has low stiffness, the medium may be deformed or damaged. Further, in the case where the medium (for example, a label sheet) has adhesive labels on a surface thereof, adhesive agent may protrude from the side end of the medium and stick to the flange. In such a case, it may be necessary to clean the flange, or other problems may occur.

### SUMMARY OF THE INVENTION

An embodiment of the present invention is intended to suppress deformation and damage of a medium, and to suppress skew and meandering of the medium.

According to an aspect of the present invention, there is provided a medium transport apparatus including a transport section that transports a medium so that a widthwise direction of the medium is directed to a predetermined direction, and a contact roller that contacts the medium transported by the transport section. An axial direction of the contact roller is inclined with respect to the predetermined direction. A flange is disposed at a side of the contact roller in the axial direction. The flange has a surface defining a position of the medium. The surface is perpendicular to the predetermined direction.

With such a configuration, the medium is displaced according to an inclination of the contact roller, and contacts the surface of the flange perpendicular to the axial direction of the contact roller. A side end of the medium and the surface of the flange are not parallel, and friction therebetween is reduced. Therefore, it becomes possible to suppress deformation and damage of the medium, and suppress protrusion of adhesive agent from the side end of the medium. Further, it becomes possible to suppress skew and meandering of the medium, and to stably transport the medium.

According to another aspect of the present invention, there is provided an image forming apparatus including the medium transport apparatus and an image forming section that forms an image on the medium transported by the medium transport apparatus.

### BRIEF DESCRIPTION OF THE DRAWINGS

In the attached drawings:

FIG. 1 is a schematic view showing a configuration of an image forming apparatus according to an embodiment of the present invention;

FIG. 2 shows configurations of process units according to the embodiment of the present invention;

FIG. 3 shows a configuration of a medium transport apparatus according to the embodiment of the present invention;

FIG. 4 is a perspective view showing the configuration of the medium transport apparatus according to the embodiment of the present invention;

FIG. 5 is a perspective view showing a driving unit of a medium holder according to the embodiment of the present invention;

FIG. 6 is a perspective view showing the driving unit of the medium holder according to the embodiment of the present invention;

FIG. 7 is a schematic view for illustrating an inclination of a tension roller according to the embodiment of the present invention;

FIGS. 8A and 8B are a perspective view and a sectional view showing a tension roller and its surroundings according to the embodiment of the present invention;

FIG. 9 is a block diagram showing a control system of the image forming apparatus according to the embodiment of the present invention;

FIGS. 10A and 10B are a plan view and a side view showing a function of the medium transport apparatus according to the embodiment of the present invention;

FIGS. 11A and 11B are a plan view and a side view showing a function of a medium transport apparatus of a first comparison example;

FIGS. 12A and 12B are a plan view and a side view showing a function of a medium transport apparatus of a second comparison example;

FIG. 13 is a sectional view showing a configuration of a tension roller according to a first modification of the embodiment; and

FIG. 14 is a schematic view showing a configuration of an image forming apparatus according to a second modification of the embodiment.

### DETAILED DESCRIPTION OF THE PREFERRED EMBODIMENT

### <Configuration of Image Forming Apparatus>

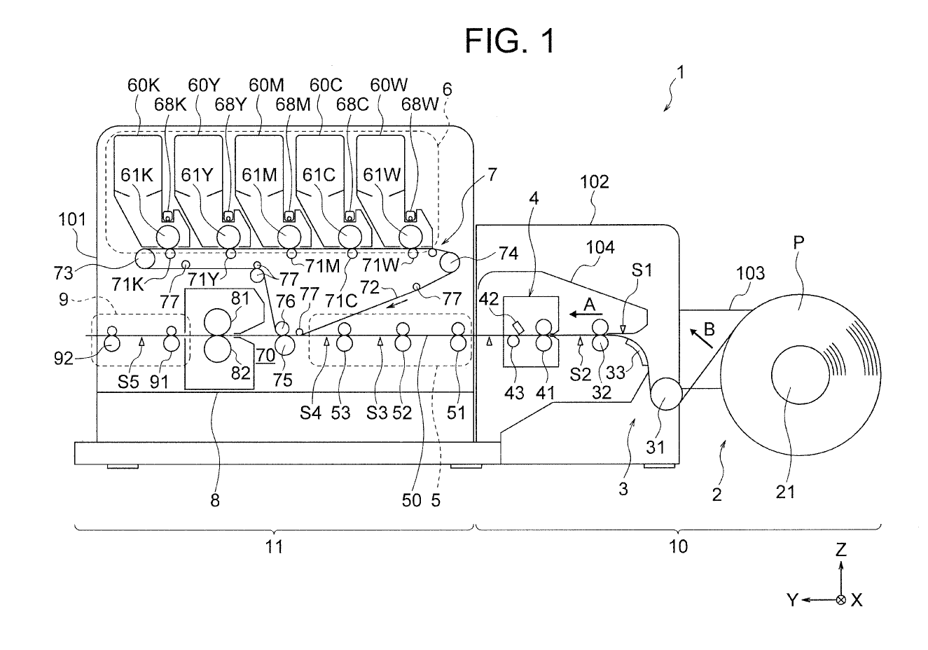

Hereinafter, an image forming apparatus according to the embodiment of the present invention will be described. FIG. 1 is a schematic view showing a configuration of an image forming apparatus 1 according to the embodiment. The image forming apparatus 1 includes a medium transport apparatus 10 that transports a continuous medium P (for example, a rolled sheet), and an image forming section 11 that forms an image on the medium P transported by the medium transport apparatus 10. First, a configuration of the image forming section 11 will be described.

### <Configuration of Image Forming Section>

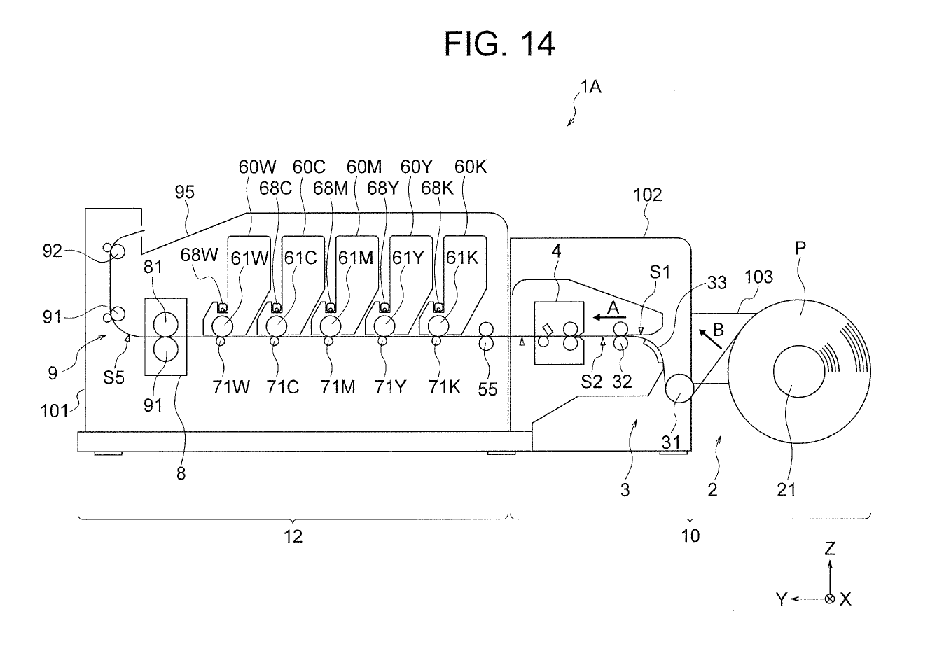

The image forming section 11 is configured to form an image (more specifically, a color image) on the medium P using an electrophotographic method. The image forming section 11 of FIG. 1 uses an intermediate transfer method, but may also use a direct transfer method (see FIG. 14).

The image forming section 11 is configured to form a color image using a black toner, a yellow toner, a magenta toner, a cyan toner and a special toner (in this example, a white toner). In this regard, the image forming section 11 may also be configured to form a monochrome image. Further, the image forming section 11 may also be configured to use no special toner.

The image forming section 11 includes a timing adjusting unit 5 (i.e., a timing adjusting mechanism) that receives the medium P fed from the medium transport apparatus 10 and ejects the medium P at a certain timing, process units (i.e., image forming units) 60K, 60Y, 60M, 60C and 60W that form toner images based on image data, a transfer section 7 that transfers the toner images formed by the process units 60K, 60Y, 60M, 60C and 60W to the medium P via an intermediate transfer belt 72 (i.e., an intermediate transfer body), a fixing device 8 that fixes the toner image (transferred to the medium P) to the medium P, and an ejection section 9 that ejects the medium P with the fixed toner image. These elements are housed in a housing 101.

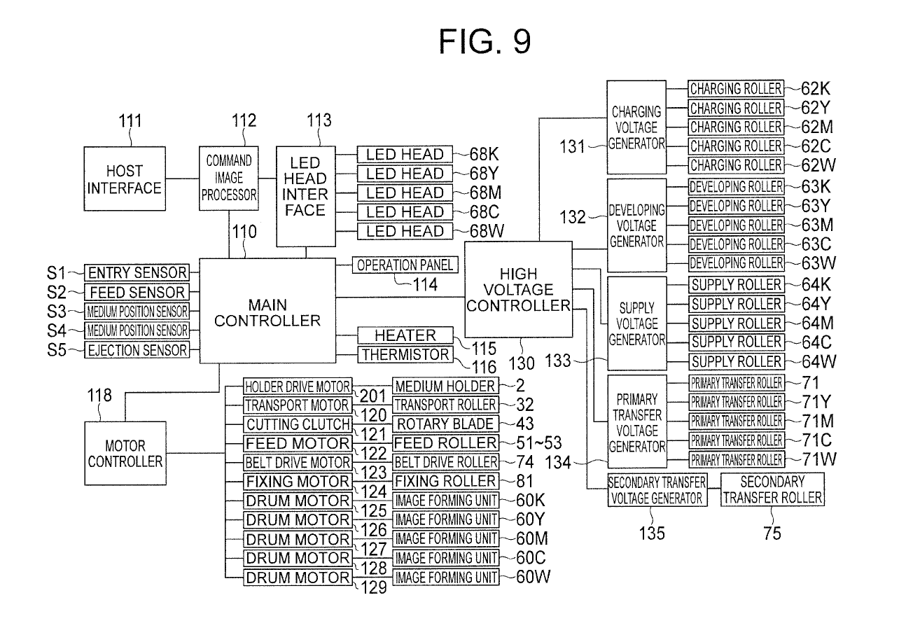

The image forming section 11 has a transport path 50 along which the medium P (transported from the medium transport apparatus 10) is transported. In a particular example, the transport path 50 extends horizontally (i.e., from right to left in FIG. 1). The timing adjusting unit 5 includes three pairs of feed rollers 51, 52 and 53 arranged in this order from upstream to downstream along the transport path 50. The feed rollers 51, 52 and 53 are driven by a common feed motor 122 (FIG. 9) to rotate at the same speed and at the same timing. The timing adjusting unit 5 includes medium position sensors S3 and S4 that detect a passage of a leading end of the medium P transported along the transport path 50. The medium position sensors S3 and S4 are used to match a position of the leading end of the medium P and a position of a leading end of the toner image on the intermediate transfer belt 72 as described later.

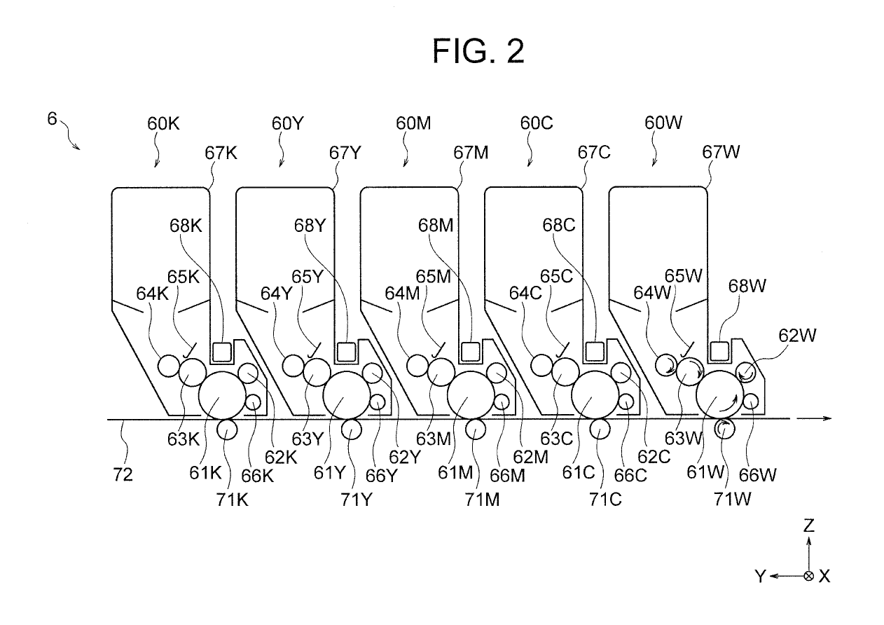

FIG. 2 shows configurations of the process units 60K, 60Y, 60M, 60C and 60W. The process units 60K, 60Y, 60M, 60C and 60W are configured to form toner images (i.e., developer images) using black, yellow, magenta, cyan and white (special) toners. The process units 60K, 60Y, 60M, 60C and 60W are arranged in a moving direction of the intermediate transfer belt 72 (i.e., from left to right in FIG. 2) described later. LED heads 68K, 68Y, 68M, 68C and 68W as exposure devices are disposed above and facing the respective photosensitive drums (described later) of the process units 60K, 60Y, 60M, 60C and 60W.

The process units 60K, 60Y, 60M, 60C and 60W have the same configurations except for the toners. Therefore, a configuration of the process unit 60K will be described herein.

The process unit 60K includes a photosensitive drum 61K as an image bearing body, a charging roller 62K as a charging member, a developing roller 63K as a developer bearing body, a supply roller 64K as a supply member, a developing blade 65K as a developer regulation member, a cleaning member 66K, and a toner cartridge 67K as a developer storage body.

The photosensitive drum 61K includes a cylindrical conductive support body formed of aluminum or the like, and a photosensitive layer (including a charge generating layer and a charge transport layer) formed on a surface of the conductive support body. The photosensitive drum 61K is driven by a drum motor 125 (FIG. 9) and rotates counterclockwise in FIG. 2. The photosensitive layer of the photosensitive drum 61K is exposed with light emitted by the LED head 68K, and an electrostatic latent image is formed thereon.

The charging roller 62K includes, for example, a metal shaft and a semiconductive epichlorohydrin rubber layer formed thereon. The charging roller 62K is disposed so as to contact a surface of the photosensitive drum 61K. The charging roller 62K rotates following a rotation of the photosensitive drum 61K. The charging roller 62K is applied with a charging voltage by a charging voltage generator 131 (FIG. 9), and uniformly charges the surface of the photosensitive drum 61K.

The developing roller 63K includes, for example, a metal shaft and a semiconductive urethane rubber layer formed thereon. The developing roller 63K is disposed so as to contact the surface of the photosensitive drum 61K. The developing roller 63K is driven by a rotation force transmitted from the drum motor 125 (FIG. 9), and rotates in a rotating direction opposite to a rotating direction of the photosensitive drum 61K (i.e., so that surfaces facing each other move in the same direction). The developing roller 63K is applied with a developing voltage by a developing voltage generator 132 (FIG. 9), and develops an electrostatic latent image on the surface of the photosensitive drum 61K with the toner.

The supply roller 64K includes, for example, a metal shaft and a semiconductive foamed silicone sponge layer formed thereon. The supply roller 64K is disposed so as to contact the developing roller 63K, or disposed at a certain distance from the developing roller 63K. The supply roller 64K is driven by a rotation force transmitted from the drum motor 125 (FIG. 9), and rotates in the same rotating direction as the developing roller 63K. The supply roller 64K is applied with a supply voltage by a supply voltage generator 133 (FIG. 9), and supplies the toner to the developing roller 63K.

The developing blade 65K is a blade formed of, for example, stainless steel. The developing blade 65K is disposed so as to contact a surface of the developing roller 63K. The developing blade 65K regulates a thickness of a toner layer formed on the surface of the developing roller 63K.

The cleaning member 66K is constituted by, for example, a roller or a blade formed of urethane rubber. The cleaning member 66K is disposed so as to contact the surface of the photosensitive drum 61K. The cleaning member 66K is configured to remove a residual toner remaining on the surface of the photosensitive drum 61K.

The toner cartridge 67K is detachably mounted to an upper part of the process unit 60K. The toner cartridge 67K stores a toner therein, and supplies the toner to the developing roller 63K and the supply roller 64K. The toner cartridges 67K, 67Y, 67M, 67C and 67W respectively store black, yellow, magenta, cyan and white toners. The toner cartridge 67W may not only store a white toner, but may also store, for example, a clear toner, a transparent toner or the like.

Referring back to FIG. 1, the transfer section 7 includes transfer rollers 71K, 71Y, 71M, 71C and 71W as primary transfer bodies. The transfer rollers 71K, 71Y, 71M, 71C and 71W are disposed so as to contact the photosensitive drums 61K, 61Y, 61M, 61C and 61W from below. Each of the transfer rollers 71K, 71Y, 71M, 71C and 71W includes, for example, a metal shaft and a foamed rubber layer formed thereon.

Each of the transfer rollers 71K, 71Y, 71M, 71C and 71W is applied with a primary transfer voltage by a primary transfer voltage generator 134 (FIG. 9). With the primary transfer voltage, the toner images of respective colors are transferred from the surfaces of the photosensitive drums 61K, 61Y, 61M, 61C and 61W to the intermediate transfer belt 72 described below.

The intermediate transfer belt 72 is disposed so as to pass through between the photosensitive drums 61K, 61Y, 61M, 61C and 61W and the transfer rollers 71K, 71Y, 71M, 71C and 71W. The intermediate transfer belt 72 is an endless belt formed of semiconductive plastic or the like.

The intermediate transfer belt 72 is wound around a belt driving roller 74, a driven roller 73 and a secondary transfer backup roller 76 that are disposed on an inner circumference side of the intermediate transfer belt 72. The belt driving roller 74 is driven by a belt driving motor 123 (FIG. 9), and rotates clockwise in FIG. 1 so as to move the intermediate transfer belt 72 in a direction shown by an arrow. The driven roller 73 applies a certain tension to the intermediate transfer belt 72. A plurality of guide rollers 77 are disposed along a moving path of the intermediate transfer belt 72 for guiding the movement of the intermediate transfer belt 72.

A secondary transfer roller 75 as a secondary transfer body is disposed so as to face the secondary transfer backup roller 76 via the intermediate transfer belt 72. A secondary transfer portion 70 is formed by the secondary transfer roller 75 and the secondary transfer backup roller 76. The secondary transfer portion 70 is disposed downstream of the above described timing adjusting unit 5 along the transport path 50 in the image forming section 11.

At the secondary transfer portion 70, the medium P fed from the timing adjusting unit 5 and the intermediate transfer belt 72 overlap each other. The secondary transfer roller 75 is applied with a secondary transfer voltage by a secondary transfer voltage generator 135 (FIG. 9). With the secondary transfer voltage, the toner image is transferred from a surface of the intermediate transfer belt 72 to the medium P.

The fixing device 8 is disposed downstream (i.e., left in FIG. 1) of the secondary transfer portion 70 along the transport path 50. The fixing device 8 includes a heating roller 81 and a pressure roller 82.

The heating roller 81 includes, for example, a metal core of aluminum having a hollow cylindrical shape, a heat-resistant resilient layer of silicone rubber covering the metal core, and a PFA (tetrafluoro-ethylene perfluoroalkyl vinyl ether copolymer) tube covering the heat-resistant resilient layer. A heater 115 (FIG. 9) such as a halogen lamp is disposed inside the metal core of the heating roller 81. The heating roller 81 is driven to rotate by a fixing motor 124 (FIG. 9).

The pressure roller 82 includes, for example, a metal core of aluminum, a heat-resistant resilient layer of silicone rubber covering the metal core, and a PFA tube covering the heat-resistant resilient layer. The pressure roller 82 is pressed against the heating roller 81 so as to form a nip (i.e., a fixing nip) between the heating roller 81 and the pressure roller 82. The fixing device 8 is provided with a thermistor 116 (FIG. 9) as a temperature detector for detecting a surface temperature of the heating roller 81.

The ejection section 9 is disposed downstream (i.e., left in FIG. 1) of the fixing device 8 along the transport path 50. The ejection section 9 ejects the medium P with the fixed toner image to outside the image forming section 11. The ejection section 9 includes two pairs of ejection rollers 91 and 92. These ejection rollers 91 and 92 are driven to rotate by the above described fixing motor 124 (FIG. 9). The ejection section 9 includes an ejection sensor S5 for detecting arrival of the medium P at an ejection position.

Hereinafter, a direction of a rotation axis of each of the photosensitive drums 61K, 61Y, 61M, 61C and 61W (i.e., a direction perpendicular to the page of FIG. 1) will be referred to an X direction. More specifically, a surface side of the page of FIG. 1 will be referred to a −X direction, and a back side of the page of FIG. 1 will be referred to a +X direction.

Rotation axes of respective rollers of the process units 60K, 60Y, 60M, 60C and 60W, the transfer rollers 71K, 71Y, 71M, 71C and 71W, the belt driving roller 74, the driven roller 73, the secondary transfer roller 75 and the secondary transfer backup roller 76 are parallel to the X direction. Similarly, rotation axes of respective rollers of the timing adjusting unit 5, the fixing device 8 and the ejection section 9 are also parallel to the X direction.

A direction perpendicular to the X direction and in which the medium P passes the secondary transfer portion 70 (i.e., the secondary transfer roller 75 and secondary transfer backup roller 76) will be referred to as a Y direction. More specifically, a direction in which the medium P passes the secondary transfer portion 70 (i.e., from right to left in FIG. 1) will be referred to as a +Y direction, and the opposite direction will be referred to as a −Y direction.

A direction (i.e., a vertical direction) perpendicular to both of the X direction and the Y direction will be referred to as a Z direction. More specifically, an upward direction will be referred to as a +Z direction, and a downward direction will be referred to as a −Z direction.

### <Medium Transport Apparatus>

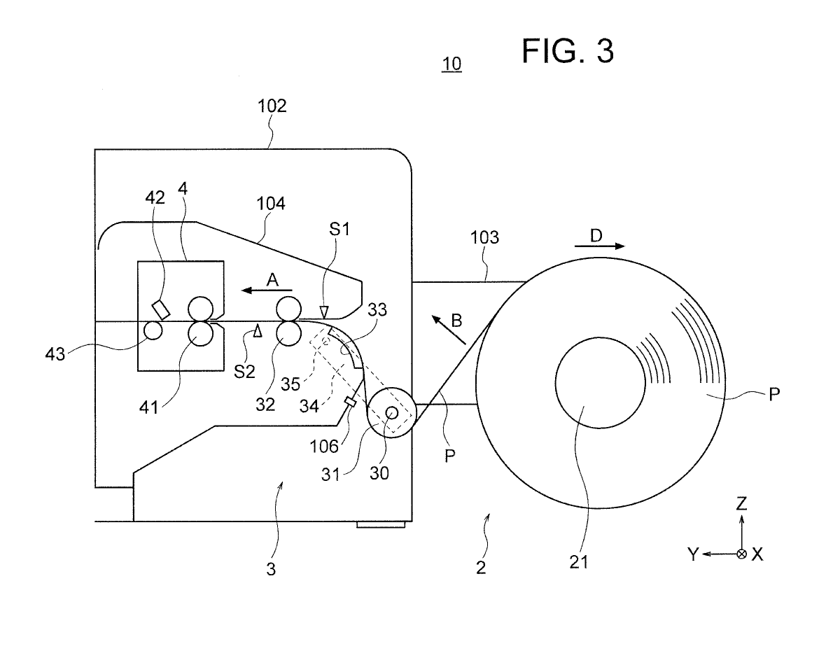

Next, the medium transport apparatus 10 will be described. FIG. 3 is a schematic view showing a configuration of the medium transport apparatus 10. The medium transport apparatus 10 includes a medium holder 2 as a medium holding portion that holds the medium P wound in a roll shape, a feeding section 3 as a medium feeder that pulls out the medium P from the medium holder 2 and transports the medium P, and a cutting section 4 that cuts the medium P transported by the feeding section 3. The medium P is a continuous medium (i.e., a continuous form) having a width of, for example, 130 mm.

The feeding section 3 and the cutting section 4 are housed in a housing 102 attached to the housing 101 of the image forming section 11. Further, the medium holder 2 is held by arms 103 mounted to the housing 102.

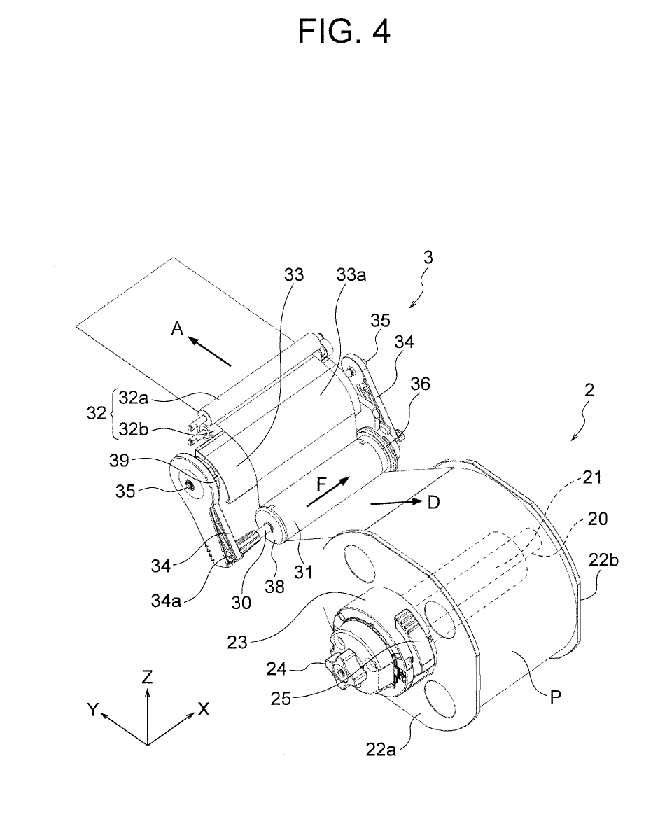

FIG. 4 is a perspective view showing the medium holder 2 and the feeding section 3 of the medium transport apparatus 10. The medium holder 2 has a holder shaft 21 (i.e., a holding member or a winding core) that holds the medium P wound in a roll shape. An axial direction of the holder shaft 21 is parallel to the X direction. A rotation shaft 20 is provided so as to penetrate a radial center of the holder shaft 21 and extend in the X direction. A pair of holder plates 22a and 22b are mounted to the rotation shaft 20. The holder plates 22a and 22b are configured to guide both ends of the medium P in a widthwise direction (i.e., the X direction).

Of the holder plates 22a and 22b, the holder plate 22a on the −X side is detachably mounted to the rotation shaft 20. When the medium P in a roll shape is mounted to the holder shaft 21, the holder plate 22a is once detached from the rotation shaft 20. A bobbin 23 for fixing the holder plate 22a to the rotation shaft 20 is mounted to the −X side of the holder plate 22a. The bobbin 23 has a knob 24 rotated (operated) by a user for reducing slackness of the medium P, and a grip 25 operated by the user for locking the bobbin 23 to the rotation shaft 20.

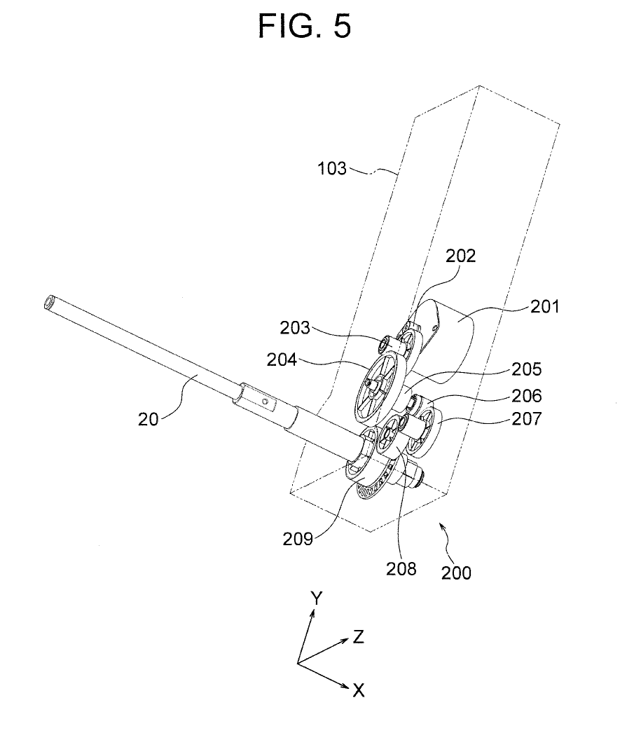

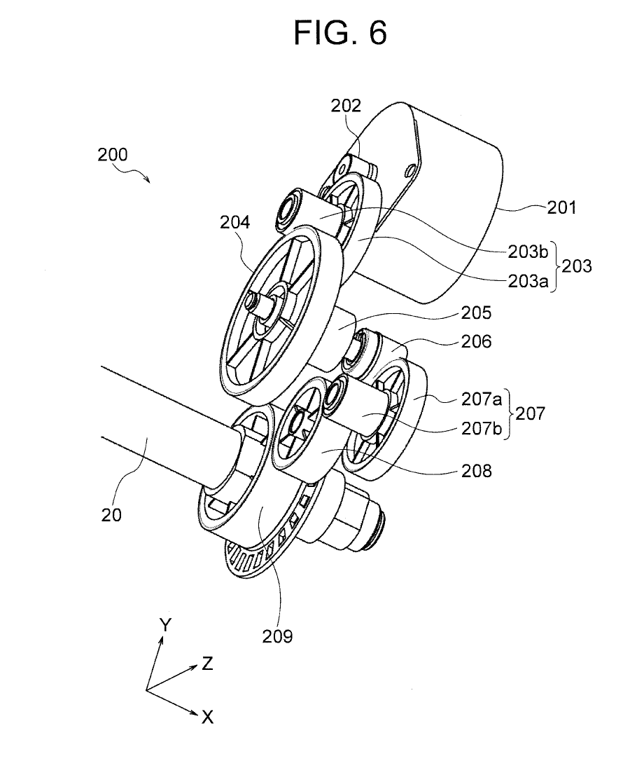

FIG. 5 is a perspective view showing a basic configuration of a driving unit 200 for driving the rotation shaft 20 of the medium holder 2. FIG. 6 is a perspective view showing a part of the driving unit 200 in an enlarged scale. The medium holder 2 is configured to apply a tension to the medium P pulled out and transported from the holder shaft 21 by the transport rollers 32 of the feeding section 3. More specifically, the medium holder 2 is configured to apply a tension (i.e., a back tension) to the medium P in a direction opposite to a transport direction of the medium P.

As shown in FIG. 6, the driving unit 200 has a holder drive motor 201 as a driving source, a two-stage gear 203, a transmission gear 204, a torque limiter 205, a transmission gear 206, a two-stage gear 207, a transmission gear 208, and a shaft gear 209. These elements of the driving unit 200 are provided in the arm 103 (see FIG. 5). The two-stage gear 203 has a larger gear 203a and a smaller gear 203b that are coaxial with each other. The two-stage gear 207 has a larger gear 207a and a smaller gear 207b that are coaxial with each other.

The motor gear 202 is fixed to an output shaft of the holder drive motor 201. The motor gear 202 meshes with the larger gear 203a of the two-stage gear 203. The smaller gear 203b of the two-stage gear 203 meshes with the transmission gear 204. The transmission gear 204 is connected with the transmission gear 206 through the torque limiter 205. The transmission gear 206 meshes with the larger gear 207a of the two-stage gear 207, and the smaller gear 207b meshes with the transmission gear 208. The transmission gear 208 meshes with the shaft gear 209 fixed to the rotation shaft 20.

With such a configuration, a driving force of the holder drive motor 201 is transmitted to the rotation shaft 20 through the torque limiter 205 and the respective gears. The rotation shaft 20 rotates together with the holder shaft 21. The holder drive motor 201 rotates in a direction (shown by an arrow D in FIG. 4) so as to wind up the medium P around the holder shaft 21. Further, when the transport rollers 32 start transporting the medium P, a slip occurs in the torque limiter 205. By the slip in the torque limiter 205, the holder shaft 21 rotates following the transported medium P while applying a back tension to the medium P.

As shown in FIG. 4, the feeding section 3 includes a pair of transport rollers 32 that pull out the medium P from the medium holder 2. The transport rollers 32 include an upper roller 32a and a lower roller 32b. Rotation axes of the upper roller 32a and the lower roller 32b are parallel to the X direction. The lower roller 32b is driven to rotate by a transport motor 120 (FIG. 9). The upper roller 32a and the lower roller 32b form a nip therebetween. The upper roller 32a rotates following a rotation of the lower roller 32b.

A tension roller 31 (i.e., a contact roller or a guide roller) is disposed between the holder shaft 21 and the transport rollers 32, and applies a tension to the medium P. The tension roller 31 is preferably disposed below a plane connecting an uppermost portion of the holder shaft 21 and a nip of the transport rollers 32 (i.e. the nip between the upper roller 32a and the lower roller 32b) in order to effectively apply a tension to the medium P.

The tension roller 31 is supported so as to be rotatable about a shaft 30. Both ends of the shaft 30 are held by a pair of swingable levers (i.e., swingable support bodies) 34. The levers 34 are swingable about a swing shaft 35 parallel to the X direction. The swing shaft 35 is disposed on the −Y side of the transport rollers 32, and is supported by a side frame 104 (FIG. 3) in the housing 102.

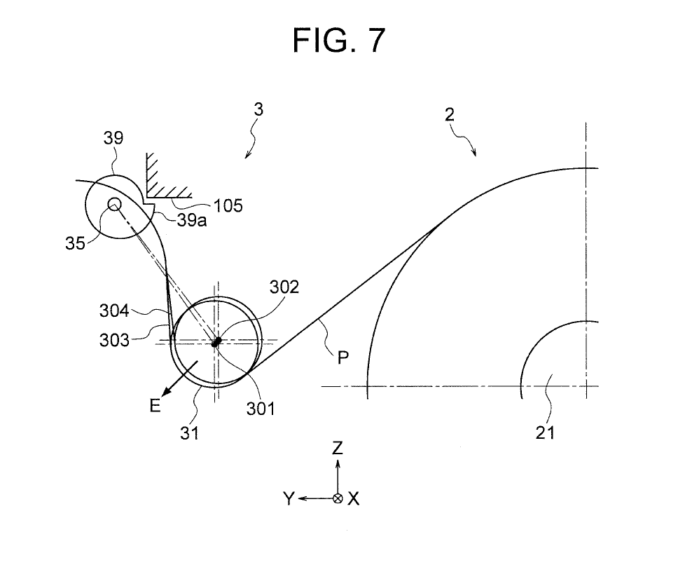

Both levers 34 swing integrally with each other about the swing shaft 35. Further, a cam (i.e., a swinging regulating member) 39 is mounted to the lever 34. The cam 39 regulates a swinging angle of the lever 34. The cam 39 has a contact portion 39a (FIG. 7). When the levers 34 swing upward to a predetermined angle, the contact portion 39a contacts a contact member 105 (FIG. 7) provided in the feeding section 3.

Further, when the levers 34 swing downward (i.e., in a direction in which a tension of the medium P increases) to a predetermined angle, the lever 34 contacts a stopper 106 (FIG. 3) provided on the side frame 104 in the housing 102. Swinging ranges (angles) of the levers 34 are regulated in this way. The swinging ranges of the levers 34 may also be regulated in other way.

Mounting holes 34a are formed on the levers 34. Both ends of the shaft 30 engage the mounting holes 34a of the levers 34. Positions of the mounting holes 34a of the levers 34 are so set that an axial direction of the tension roller 31 is inclined with respect to the X direction.

FIG. 7 is a schematic view for illustrating an inclination of the tension roller 31. The tension roller 31 has a rotation center 301 at an end in the −X direction, and a rotation center 302 at an end in the +X direction. The tension roller 31 is disposed so that the rotation center 301 is displaced in the +Y direction and in the −Z direction relative to the rotation center 302.

A displacement amount (i.e., a shifting amount) between the rotation centers 301 and 302 of the tension roller 31 in the Y direction is, for example, 0.8 mm. A displacement amount between the rotation centers 301 and 302 of the tension roller 31 in the Z direction is, for example, 0.6 mm. A displacement amount between the rotation centers 301 and 302 of the tension roller 31 in a displacement direction (shown by an arrow E in FIG. 7) is, for example, 1.0 mm. A length of the tension roller 31 is, for example, 180 mm. An inclination angle of the tension roller 31 is, for example, 0.25 degrees.

With such an inclination of the tension roller 31, a length 303 of the medium P from the holder shaft 21 to the transport rollers 32 at the end in the −X direction is longer than a length 304 of the medium P from the holder shaft 21 to the transport rollers 32 at the end in the +X direction. A difference between the lengths 303 and 304 is, for example, 1.5 mm. Therefore, a difference in tension between both ends of the medium P in the widthwise direction occurs. With such a difference in tension, a force is applied to the medium P to cause the medium P to be displaced in the +X direction.

In this regard, the inclination of the tension roller 31 and the difference between the lengths 303 and 304 at both ends of the medium P are not limited to the above described values, but may be suitably determined based on a positional relationship among respective rollers (i.e., the transport rollers 32, the tension roller 31 and the holder shaft 21), a transport force by the transport rollers 32, a back tension applied by the holder shaft 21, a kind of the medium P, or the like.

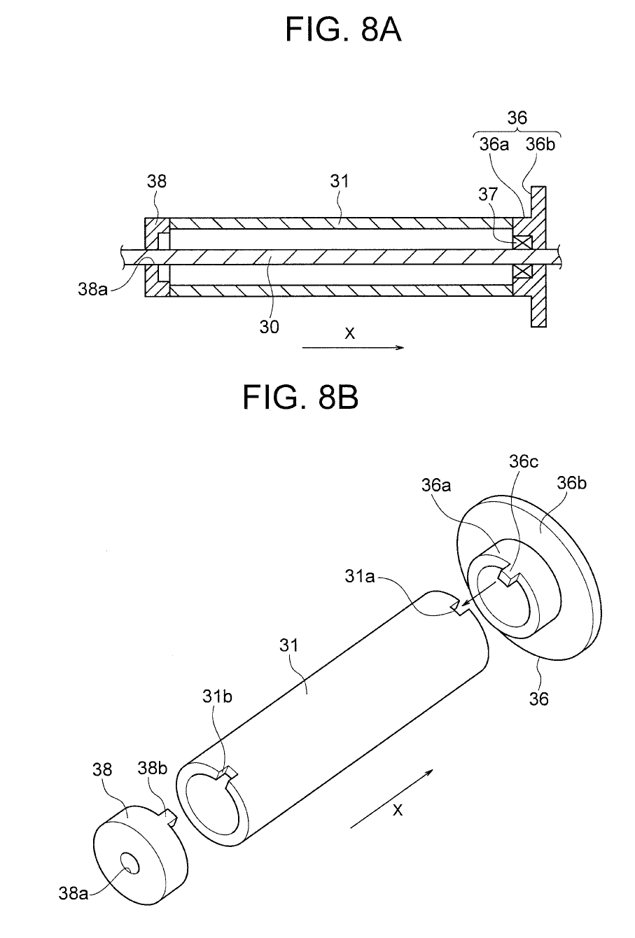

FIG. 8A is a sectional view showing the tension roller 31 and its surroundings. As shown in FIG. 8A, the tension roller 31 has a hollow cylindrical shape. A flange 36 is fixed to an end (i.e., an end in the +X direction) of the tension roller 31 in the axial direction. An annular member 38 formed of resin is fixed to the other end (i.e., an end in the −X direction) of the tension roller 31 in the axial direction.

The flange 36 is rotatably mounted to the shaft 30 via a bearing 37. Further, the annular member 38 has a hole 38a through which the shaft 30 is inserted. The annular member 38 is rotatable about the shaft 30 by a sliding contact between the hole 38a and the shaft 30. In this way, the tension roller fixed to the flange 36 and the annular member 38 is rotatable about the shaft 30.

FIG. 8B is a perspective view showing the tension roller 31, the flange 36 and the annular member 38. The flange 36 has a cylindrical body 36a at a radial center area. The cylindrical body 36a has substantially the same diameter as the tension roller 31. An end surface of the tension roller 31 in the +X direction is fixed to an end surface of the cylindrical body 36a.

A surface of the flange 36 facing the tension roller 31 is referred to as a regulation surface 36b, and is perpendicular to the axial direction of the tension roller 31. The medium P displaced in the +X direction according to the inclination of the tension roller 31 contacts the regulation surface 36b of the flange 36. In this state, the medium P is in point contact with the regulation surface 36b, and therefore friction between the medium P and the regulation surface 36b can be reduced. This will be described later.

A convex portion 36c (i.e., an engaging portion) is formed on an end surface of the cylindrical body 36a of the flange 36 facing the tension roller 31. A concave portion 31a (i.e., a to-be-engaged portion) engaging the convex portion 36c is formed on an end surface of the tension roller 31 facing the flange 36. By engagement between the convex portion 36c and the concave portion 31a, the tension roller 31 and the flange 36 rotate together with each other.

Further, a convex portion 38b (i.e., an engaging portion) is formed on an end surface of the annular member 38 facing the tension roller 31. A concave portion 31b (i.e., a to-be-engaged portion) engaging the convex portion 38b is formed on an end surface of the tension roller 31 facing the annular member 38. By engagement between the convex portion 38b and the concave portion 31b, the tension roller 31 and the annular member 38 rotate together with each other. That is, the tension roller 31, the flange 36 and the annular member 38 rotate together with each other about the shaft 30.

Since the tension roller 31 and the flange 36 rotate together with each other as described above, the medium P does not continuously contact the same point on the regulation surface 36b, and therefore a friction reduction effect can be enhanced. This will be described later.

Referring back to FIG. 4, a transport guide 33 for guiding the medium P is disposed between the tension roller 31 and the transport rollers 32. The transport guide 33 has a guide surface 33a in the form of a curved surface (for example, a circular-arc surface) that contacts the medium P. The transport guide 33 is fixed to, for example, the side frame 104 (FIG. 3) of the housing 102. The transport guide 33 is configured to smoothly guide the medium P (applied with a tension by the tension roller 31) to the transport rollers 32. In this regard, the transport guide 33 extends in a direction (i.e., the widthwise direction) parallel to the X direction.

Referring back to FIG. 3, an entry sensor S1 and a feed sensor S2 are disposed respectively upstream (i.e., in the −Y direction) and downstream (i.e., in the +Y direction) of the transport rollers 32 in the transport direction of the medium P transported by the transport rollers 32. The entry sensor S1 and the feed sensor S2 detect passage of a leading end of the medium P. The entry sensor S1 is used to check whether the medium P is set. The feed sensor S2 is used to determine a timing at which the cutting section 4 cuts the medium P.

In the transport direction of the medium P transported by the transport rollers 32, the cutting section 4 is disposed downstream (i.e., in the +Y direction) of the feed sensor S2. The cutting section 4 includes a pair of transport rollers 41 that transport the medium P transported from the transport rollers 32, and a fixed blade 42 and a rotary blade 43 that cut the medium P transported by the transport rollers 41.

As is the case with the transport rollers 32 of the feeding section 3, the transport rollers 41 are driven to rotate by the transport motor 120, and transport the medium P. The fixed blade 42 and the rotary blade 43 are disposed so as to vertically sandwich the medium P. The rotary blade 43 receives a rotation force transmitted from the transport motor 120 through a cutting crutch 121 (FIG. 9). When the cutting crutch 121 (FIG. 9) turns on, the rotary blade 43 rotates relative to the fixed blade 42, and cuts the medium P.

### <Control System>

FIG. 9 is a block diagram showing a control system of the image forming apparatus 1. The image forming apparatus 1 includes a main controller 110, a host interface 111, a command image processor 112, an LED head interface 113, an operation panel 114, a heater 115, a thermistor 116, a high voltage controller 130, a charging voltage generator 131, a developing voltage generator 132, a supply voltage generator 133, a primary transfer voltage generator 134, and a secondary transfer voltage generator 135.

The image forming apparatus 1 further includes a motor controller 118, a holder drive motor 201, a transport motor 120, a cutting crutch 121, a feed motor 122, a belt driving motor 123, a fixing motor 124, and drum motors 125, 126, 127, 128 and 129.

The main controller 110 controls respective elements of the image forming apparatus 1, and includes a CPU (Central Processing Unit) and a storage device. The main controller 110 is connected with the command image processor 112, the LED head interface 113, the motor controller 118, the high voltage controller 130, the sensors S1, S2, S3, S4 and S5, the heater 115, and the thermistor 116.

The host interface 111 receives a command and image data transmitted from an external device such as a computer, and outputs the command and the image data to the command image processor 112. The command image processor 112 processes the command and the image data outputted from the host interface 111, and outputs the processed data to the main controller 110.

The LED head interface 113 controls light emission of the LED heads 68K, 68Y, 68M, 68C and 68K based on the image data outputted from the command image processor 112 to the main controller 110.

The motor controller 118 controls the holder drive motor 201, the transport motor 120, the cutting crutch 121, the feed motor 122, the belt driving motor 123, the fixing motor 124, and the drum motors 125, 126, 127, 128 and 129 based on instructions from the main controller 110.

The holder drive motor 201 rotates the rotation shaft 20 of the medium holder 2 to apply a back tension to the medium P. The transport motor 120 rotates the transport rollers 32 to transport the medium P. The cutting crutch 121 causes the rotary blade 43 to cut the transported medium P. The feed motor 122 rotates the feed rollers 51, 52 and 53 of the image forming section 11 to transport the medium P. The belt driving motor 123 rotates the belt driving roller 74 to drive the intermediate transfer belt 72. The fixing motor 124 rotates the heating roller 81. The drum motors 125, 126, 127, 128 and 129 rotate the photosensitive drums 61K, 61Y, 61M, 61C and 61W.

The high voltage controller 130 controls the charging voltage generator 131, the developing voltage generator 132, the supply voltage generator 133, the primary transfer voltage generator 134 and the secondary transfer voltage generator 135 according to instructions from the main controller 110.

The charging voltage generator 131 applies the charging voltage to the charging rollers 62K, 62Y, 62M, 62C and 62W. The developing voltage generator 132 applies the developing voltage to the developing rollers 63K, 63Y, 63M, 63C and 63W. The supply voltage generator 133 applies the supply voltage to the supply rollers 64K, 64Y, 64M, 64C and 64W. The primary transfer voltage generator 134 applies the primary transfer voltage to the transfer rollers 71K, 71Y, 71M, 71C and 71W. The secondary transfer voltage generator 135 applies the secondary transfer voltage to the secondary transfer roller 75.

### <Operation of Image Forming Apparatus>

An image formation operation (i.e., a printing operation) of the image forming apparatus 1 will be described. As shown in FIG. 4, in a state where the medium P is mounted to the holder shaft 21 of the medium holder 2, the medium P extends along the tension roller 31 and the transport guide 33, and the leading end of the medium P reaches the transport rollers 32. Further, positions of both ends of the medium P in the widthwise direction are regulated by the holder plates 22a and 22b.

In this state, the medium P is located at the entry sensor S1 (FIG. 3), and the entry sensor S1 outputs an ON signal. The main controller 110 recognizes that the medium P is mounted to the holder shaft 21 based on the ON signal from the entry sensor S1.

Then, the main controller 110 instructs the motor controller 118 to rotate the holder drive motor 201. As the holder drive motor 201 rotates, the rotation shaft 20 also rotates, and the holder shaft 21 rotates in a direction to wind up the medium P. Therefore, the medium P moves in a direction shown by the arrow D in FIG. 4. Since the leading end of the medium P is pinched by the nip between the transport rollers 32, the medium P is stretched tightly.

Then, the main controller 110 instructs the motor controller 118 to rotate the transport motor 120. As the transport motor 120 rotates, the transport rollers 32 pull out the medium P from the holder shaft 21 and transport the medium P in the direction shown by an arrow A in FIG. 4. The holder shaft 21 rotates following the movement of the medium P by the slip of the torque limiter 205 (FIG. 5) while applying a back tension to the medium P.

The tension roller 31 applies a tension to the medium P being pulled out from the holder shaft 21 and transported. The swingable ranges of the levers 34 supporting the tension roller 31 are regulated so that an appropriate tension is applied to the medium P. As described above, the swingable ranges of the levers 34 are regulated by the cam 39, the contact member 105 and the stopper 106.

After the transport rollers 32 start transporting the medium P, the leading end of the medium P reaches the feed sensor S2 (FIG. 3) downstream of the transport rollers 32. Then, the feed sensor S2 outputs an ON signal. Operations described below are controlled based on the timing of the ON signal from the feed sensor S2.

In this regard, the transport rollers 41 of the cutting section 4 start rotating at the same timing as the transport rollers 32 start rotating. That is, the transport rollers 41 transport the medium P fed from the transport rollers 32.

The main controller 110 instructs the motor controller 118 to rotate the feed motor 122 at a predetermined timing based on the ON signal from the feed sensor S2. This causes the feed rollers 51, 52 and 53 of the timing adjusting unit 5 to rotate. The medium P fed into the image forming section 11 (from the medium transport apparatus 10) is transported by the feed rollers 51, 52 and 53 of the timing adjusting unit 5.

The main controller 110 instructs the motor controller 118 to turn on the cutting crutch 121 at a predetermined timing (at this timing, the leading end of the medium P already passes the feed rollers 51) from the ON signal from the feed sensor S2. Therefore, the rotary blade 43 rotates relative to the fixed blade 42, and cuts the medium P.

When the medium P is cut, the tension of the medium P transported by the transport rollers 32 (while being applied with a back tension by the holder shaft 21) momentarily decreases. At this time, the levers 34 swing (i.e., the tension roller 31 swings) in response to a change in the tension of the medium P, and reduces the change in the tension of the medium P.

A cutting length of the medium P can be arbitrarily set. However, in order to stably transport the medium P, the cutting length is preferably longer than or equal to 1.5 times an interval between the transport rollers 41 and the feed rollers 51.

The main controller 110 instructs the image forming section 11 to start image formation at a predetermined timing after the ON signal from the feed sensor S2. More specifically, the main controller 110 instructs the motor controller 118 to rotate the belt driving motor 123 and the drum motors 125, 126, 127, 128 and 129. The intermediate transfer belt 72 starts moving, and respective rollers of the process units 60K, 60Y, 60M, 60C and 60W start rotating.

Further, the main controller 110 instructs the high voltage controller 130 to apply the charging voltage to the charging rollers 62K, 62Y, 62M, 62C and 62W via the charging voltage generator 131. The charging rollers 62K, 62Y, 62M, 62C and 62W uniformly charge the surfaces of the photosensitive drums 61K, 61Y, 61M, 61C and 61W.

Further, the main controller 110 instructs the LED heads 68K, 68Y, 68M, 68C and 68W to emit light via the LED head interface 113 according to image data signals of respective colors. The LED heads 68K, 68Y, 68M, 68C and 68W emit light to expose the surfaces of the photosensitive drums 61K, 61Y, 61M, 61C and 61W according to the image data signals of respective colors, and form electrostatic latent images thereon.

Further, the main controller 110 instructs the high voltage controller 130 to apply the developing voltage to the developing rollers 63K, 63Y, 63M, 63C and 63W via the developing voltage generator 132, and apply the supply voltage to the supply rollers 64K, 64Y, 64M, 64C and 64W via the supply voltage generator 133. The toners adhere to the surfaces of the developing rollers 63K, 63Y, 63M, 63C and 63W, and toner layers of uniform thicknesses are formed thereon by the developing blades 65K, 65Y, 65M, 65C and 65W.

The toners on the developing rollers 63K, 63Y, 63M, 63C and 63W adhere to the electrostatic latent images formed on the surfaces of the photosensitive drums 61K, 61Y, 61M, 61C and 61W. That is, electrostatic latent images are developed, and toner images (i.e., developer images) of respective colors are formed on the surfaces of the photosensitive drums 61K, 61Y, 61M, 61C and 61W.

Further, the main controller 110 instructs the high voltage controller 130 to apply the primary transfer voltage to the transfer rollers 71K, 71Y, 71M, 71C and 71W via the primary transfer voltage generator 134. The toner images on the surfaces of the photosensitive drums 61K, 61Y, 61M, 61C and 61W are transferred (i.e., primarily transferred) to the intermediate transfer belt 72.

That is, black, magenta, yellow, cyan, and white toner images are transferred to a surface of the intermediate transfer belt 72 in this order. As the intermediate transfer belt 72 moves by the rotation of the belt driving roller 74, the toner image transferred to the intermediate transfer belt 72 moves toward the secondary transfer portion 70.

In the timing adjusting unit 5, when the leading end of the medium P (transported by the feed rollers 51 and the like) reaches the medium position sensor S3, the medium position sensor S3 outputs an ON signal. The main controller 110 accelerates a speed of the feed motor 122 (i.e., a feeding speed of the medium P) based on the ON signal from the medium position sensor S3. This acceleration is in order to cause a leading end of the toner image on the intermediate transfer belt 72 and the leading end of the medium P to reach the secondary transfer portion 70 at the same time.

When the leading end of the medium P reaches the medium position sensor S4, the medium position sensor S4 outputs an ON signal. The main controller 110 finely adjusts the speed of the feed motor 122 (i.e., the feeding speed of the medium P) based on the ON signal from the medium position sensor S4. This fine adjustment is in order to enhance matching accuracy between the leading end of the toner image on the intermediate transfer belt 72 and the leading end of the medium P.

At a timing when the leading end of the toner image on the intermediate transfer belt 72 and the leading end of the medium P reach the secondary transfer portion 70, the main controller 110 instructs the high voltage controller 130 to apply the secondary transfer voltage to the secondary transfer roller 75 via the secondary transfer voltage generator 135. The toner image on the intermediate transfer belt 72 is transferred (i.e., secondarily transferred) to a surface of the medium P. That is, white, cyan, yellow, magenta and black toner images are transferred to the surface of the medium P in this order.

The medium P to which the toner image is transferred is transported to the fixing device 8 disposed downstream of the secondary transfer portion 70. The main controller 110 controls the heater 115 based on a detection temperature of the thermistor 116 in advance, and keeps the heating roller 81 and the pressure roller 82 at a predetermined temperature. Further, the fixing motor 124 starts rotating at the same time as when the heater 115 starts being heated. That is, when the medium P reaches the fixing device 8, the heating roller 81 is rotating. When the medium P is inserted into between the heating roller 81 and the pressure roller 82 (i.e., a fixing nip), the toner image on the surface of the medium P is heated and pressed, and is fixed to the medium P.

The medium P fed out from the fixing device 8 is ejected to outside the image forming apparatus 1 by the ejection rollers 91 and 92 of the ejection section 9. In this regard, when the ejection sensor S5 detects passage of the medium P, the ejection sensor S5 outputs an ON signal. The main controller 110 recognizes that the medium P is ejected based on the ON signal from the ejection sensor S5.

### <Function of Medium Transport Apparatus>

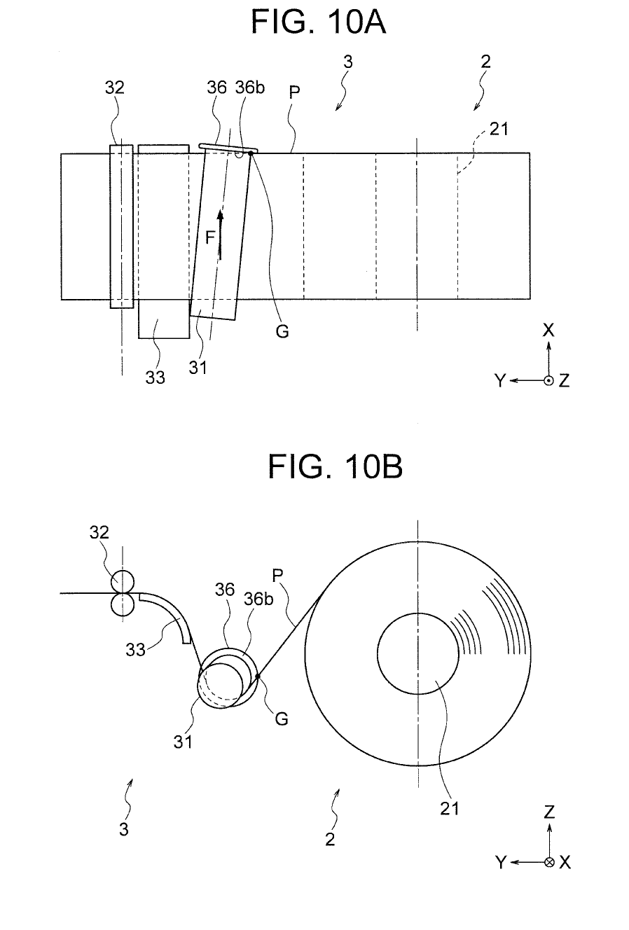

Next, a function of the medium transport apparatus 10 will be described. FIGS. 10A and 10B are a top view and a side view schematically showing a part from the holder shaft 21 to the transport rollers 32 of the medium transport apparatus 10. As described above, the axial direction of the tension roller 31 is inclined with respect to the X direction, and a difference in tension between both ends of the medium P in the widthwise direction occurs. With such a difference in tension, the medium P is applied with a force F (FIG. 10A) so that the medium P is displaced in the +X direction.

When the medium P is displaced in the +X direction by the above described force F, a side end (i.e., an end in the widthwise direction) of the medium P contacts the flange 36 disposed at the end of the tension roller 31 in the +X direction. In this state, the tension roller 31 is inclined with respect to the X direction, and the regulation surface 36b of the flange 36 is perpendicular to the axial direction of the tension roller 31. Therefore, the regulation surface 36b of the flange 36 and the side end of the medium P are not parallel to each other. As a result, the side end of the medium P contacts the flange 36 at a point G shown in FIGS. 10A and 10B.

Since the medium P is in point contact with the flange 36, friction between the medium P and the flange 36 can be reduced, as compared with a case where the medium P is in line contact with the flange. Therefore, even when a thin medium having low stiffness is used as the medium P, deformation and damage of the medium P can be suppressed. Further, even when a label sheet is used as the medium P, protrusion of adhesive agent from the side end of the medium P can be suppressed.

Further, since the side end of the medium P contacts the flange 36 as described above, skew and meandering of the medium P can be suppressed. That is, the medium P can be stably transported.

### Comparison Examples

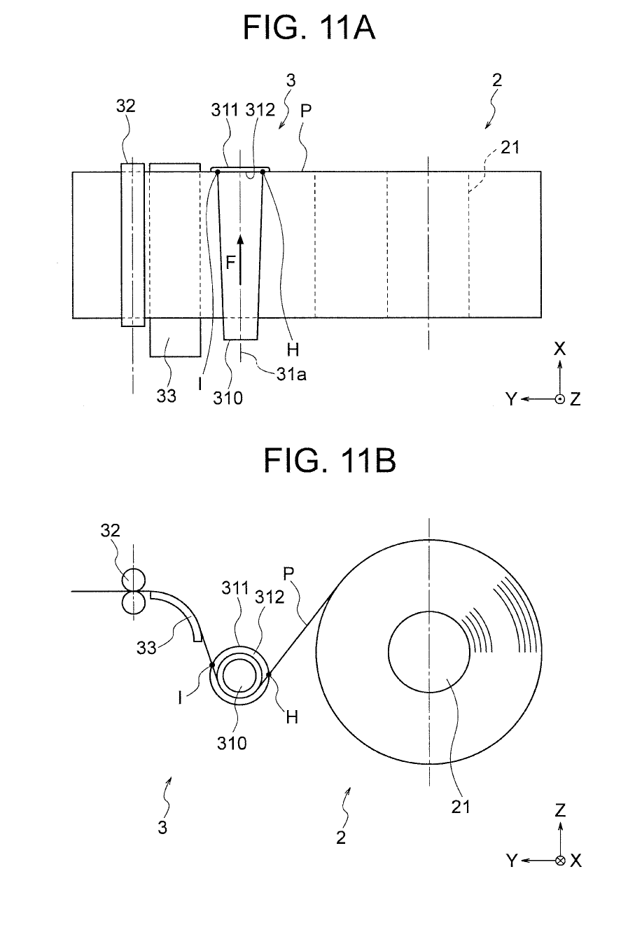

Next, comparison examples will be described. FIGS. 11A and 11B are a top view and a side view schematically showing a part from a holder shaft 21 to transport rollers 32 of a medium transport apparatus of a first comparison example. Elements of the first comparison example are assigned with the same reference numerals as those of the embodiment for convenience of illustration.

In the first comparison example, a tapered roller 310 whose axial direction is parallel to the X direction is used instead of the tension roller 31 of the embodiment. The tapered roller 310 is tapered in such a manner that an outer diameter of an end of the tapered roller 310 in the +X direction is larger than an outer diameter of an end of the tapered roller 310 in the −X direction. Further, a flange 311 is formed at the end of the tapered roller 310 in the +X direction. A surface (referred to as a regulation surface) 312 of the flange 311 facing the medium P is perpendicular to the X direction.

In this first comparison example, according to the tapered shape of the tapered roller 310, a difference in tension occurs between both ends of the medium P in the widthwise direction, and the force F is applied to the medium P. According to the force F, the medium P is displaced in the +X direction, and contacts the flange 311 of the tapered roller 310.

However, in the first comparison example, the regulation surface 312 of the flange 311 of the tapered roller 310 is perpendicular to the X direction, and therefore the side end of the medium P is in line contact with the flange 311 (for example, in a region between a point H and a point I in FIGS. 11A and 11B). Therefore, friction between the medium P and the flange 311 increases. As a result, deformation or damage of the medium P may occur. Further, when the label sheet is used as the medium P, adhesive agent may protrude from the side end of the medium P pressed against the regulation surface 312.

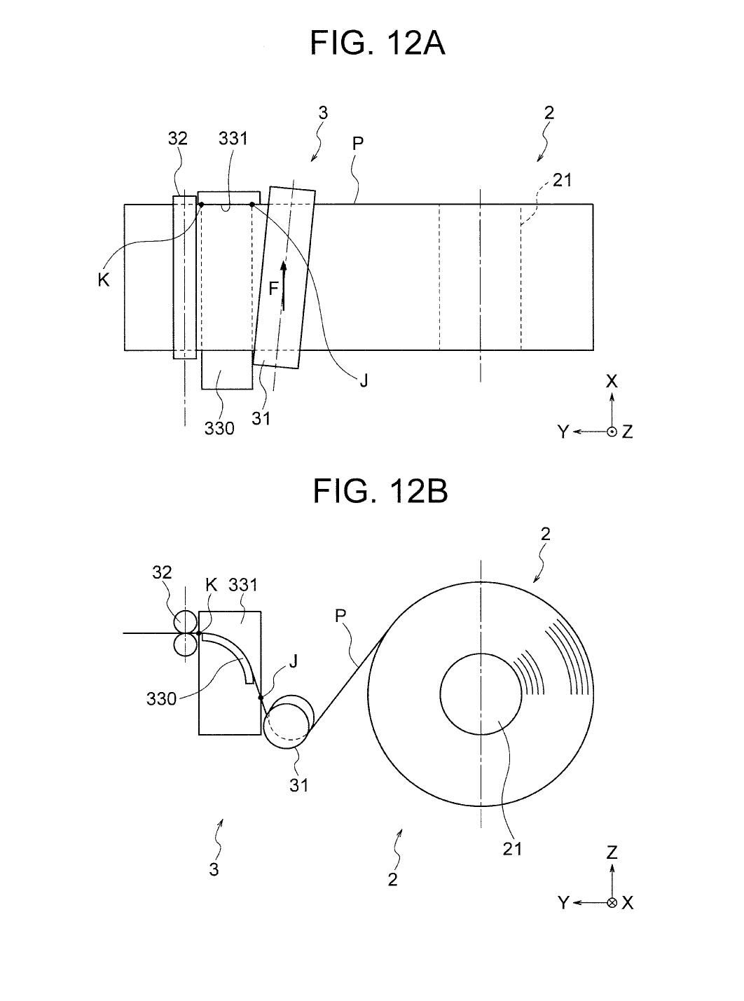

FIGS. 12A and 12B are a top view and a side view schematically showing a part from a holder shaft 21 to transport rollers 32 of a medium transport apparatus of a second comparison example. Elements of the second comparison example are assigned with the same reference numerals as those of the embodiment for convenience of illustration.

In the second comparison example, a tension roller 31 whose axial direction is inclined with respect to the X direction is used. However, the tension roller 31 has no flange 36. Instead, the transport guide 330 has a regulation surface 331 facing the medium P. The regulation surface 331 is perpendicular to the X direction.

In this second comparison example, according to the inclination of the tension roller 31, a difference in tension occurs between both ends of the medium P in the widthwise direction, and the force F is applied to the medium P. According to the force F, the medium P is displaced in the +X direction and contacts the regulation surface 331 of the transport guide 330.

However, in the second comparison example, the regulation surface 331 of the transport guide 330 is perpendicular to the X direction, and therefore the side end of the medium P is in line contact with the regulation surface 331 (for example, in a region between a point J and a point K in FIGS. 12A and 12B). Therefore, friction between the medium P and the regulation surface 331 increases. As a result, deformation or damage of the medium P may occur. Further, when the label sheet is used as the medium P, adhesive agent may protrude from the side end of the medium P pressed against the regulation surface 331.

### Effect of Embodiment

As described above, according to the embodiment of the present invention, the axial direction of the tension roller 31 (i.e., the contact roller) is inclined with respect to the X direction, and the flange 36 has the regulation surface 36b perpendicular to the axial direction of the tension roller 31. With such a configuration, the side end of the medium P is in point contact with the regulation surface 36b of the flange 36. Therefore, friction (i.e., a contact pressure) between the medium P and the flange 36 can be reduced. As a result, even when the medium P having low stiffness is used, deformation and damage of the medium P can be suppressed. Further, even when a label sheet is used as the medium P, protrusion of adhesive agent from the side end of the medium P can be suppressed.

Moreover, a variation in the transport speed caused by contact between the medium P and the flange 36 can be suppressed, and the transport speed can be kept constant. Further, the flange 36 regulates a position of the side end of the medium P, and therefore skew and meandering of the medium P can be suppressed.

Further, the tension roller 31 and the flange 36 engage each other and rotate together with each other, the medium P does not continuously contact the same point on the regulation surface 36b of the flange 36. Therefore, friction between the medium P and the flange 36 can further be suppressed.

Further, the tension roller 31 is supported by the levers 34 swingable about the swing shaft 35 in the X direction, and therefore fluctuation in the tension of the medium P can be absorbed by the swinging of the levers 34.

Further, the transport guide 33 having the curved guide surface 33a is disposed between the tension roller 31 and the transport rollers 32, and therefore the medium P (passing through the tension roller 31) can be smoothly led to the transport rollers 32.

Further, the tension roller 31 is disposed below a plane connecting the uppermost portion of the holder shaft 21 and the nip of the transport rollers 32, and therefore tension can be effectively applied to the medium P.

Further, the medium holder 2 includes the driving unit 200 applying a back tension to the medium P, and therefore tension can be effectively applied to the transported medium P.

Further, the cutting section 4 for cutting the medium P is disposed downstream of the transport rollers 32 in the transport direction, and therefore the continuous medium P (for example, a rolled sheet or the like) can be cut to a predetermined length and fed to the image forming section 11.

In this regard, although the medium transport apparatus 10 of the embodiment includes the cutting section 4, the medium transport apparatus 10 may be configured to include no cutting section 4. For example, a winding device (i.e., a taking-up device) may be disposed downstream of the image forming section 11 for winding up the medium P. In such a case, the continuous medium P can be wound up by the winding device after the image forming section 11 forms an image on the continuous medium P.

Further, in this embodiment, the tension roller 31 is swingably supported by the swingable levers 34. However, if there is little variation in the tension of the transported medium P (for example, if no cutting section 4 is provided), it is also possible that the tension roller 31 is not swingably supported.

### <First Modification>

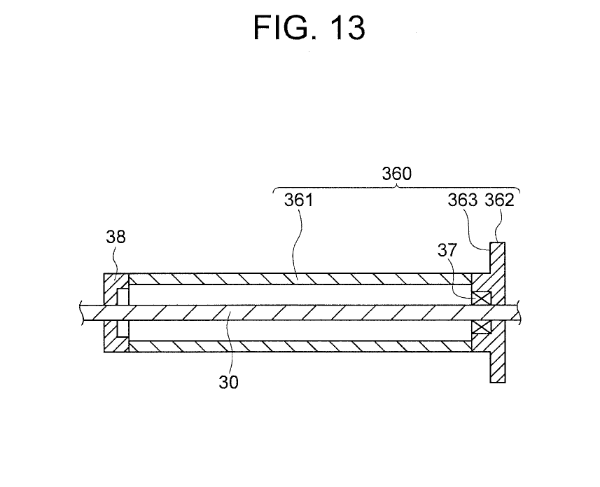

FIG. 13 is a sectional view showing a tension roller of a first modification of the embodiment. In the above described embodiment, the tension roller 31 and the flange 36 engage each other and rotate together with each other. In contrast, a tension roller 360 shown in FIG. 13 includes a cylindrical roller portion 361 and a flange 362 formed at an end of the roller portion 361 in the +X direction. The roller portion 361 and the flange 362 are formed integrally with each other. An annular member 38 (having the same configuration as the annular member 38 of the above described embodiment) is mounted to an end of the roller portion 361 in the −X direction.

A shaft 30 penetrates through a radial center of the tension roller 360. The flange 362 is supported by a bearing 37, and is rotatable about the shaft 30. The annular member 38 is rotatable about the shaft 30 by a sliding contact between the annular member 38 and the shaft 30 as in the above described embodiment.

The axial direction of the tension roller 360 is inclined with respect to the X direction as in the above described embodiment. Further, the flange 362 has a surface (referred to as a regulation surface) 363 facing the medium P. The surface 363 is perpendicular to the axial direction of the tension roller 360.

In the first modification, the axial direction of the tension roller 360 is inclined with respect to the X direction as in the above described embodiment, and the regulation surface 363 of the flange 362 is perpendicular to the axial direction of the tension roller 360. Therefore, the side end of the medium P (i.e., the end in the widthwise direction) is in point contact with the regulation surface 363 of the flange 362. As a result, friction between the medium P and the flange 36 decreases, and deformation and damage of the medium P can be suppressed.

Further, the tension roller 360 (i.e., the roller portion 361) and the flange 362 are formed integrally with each other, and therefore the medium P does not continuously contact the same point on the regulation surface 363 of the flange 362. Therefore, friction between the medium P and the flange 362 can further be suppressed.

In this regard, although the tension roller 360 and the annular member 38 are formed as separate bodies, the tension roller 360 and the annular member 38 may also be formed integrally with each other.

### <Second Modification>

FIG. 14 shows a configuration of an image forming apparatus 1A of a second modification. The image forming section 11 of the image forming apparatus 1 of the above described embodiment is configured to form an image using an intermediate transfer method. In contrast, an image forming section 12 of the image forming apparatus 1A of the second modification is configured to form an image using a direct transfer method. A configuration of the medium transport apparatus 10 is the same as that in the above described embodiment.

The image forming section 12 includes process units 60K, 60Y, 60M, 60C and 60W that form toner images (i.e., developer images) based on image data, transfer rollers 71K, 71Y, 71M, 71C and 71W as a transfer section that transfer the toner images formed by the process units 60K, 60Y, 60M, 60C and 60W directly to the medium P, a fixing device 8 that fixes the transferred toner image to the medium P, an ejection section 9 that ejects the medium P with the fixed toner image, and a housing 101 housing these elements.

The feed rollers 55 are disposed at a position where the medium P is fed from the medium transport apparatus 10. The feed rollers 55 are configured to feed the medium P to the process units 60K, 60Y, 60M, 60C and 60W. Configurations of the process units 60K, 60Y, 60M, 60C and 60W are the same as those of the above described embodiment. The process units 60K, 60Y, 60M, 60C and 60W are arranged in the transport direction of the medium P (more specifically, from right to left in FIG. 14).

The medium P transported by the feed rollers 55 passes through between the process units 60K, 60Y, 60M, 60C and 60W and the transfer rollers 71K, 71Y, 71M, 71C and 71W (i.e., a transfer portion). In this state, a moving direction of the medium P passing through the transfer portion is the Y direction (more specifically, the +Y direction).

The fixing device 8 includes a heating roller 81 and a pressure roller 82 as in the above described embodiment. The ejection section 9 includes two pairs of ejection rollers 91 and 92 that transport the medium P (transported from the fixing device 8) to a stacker part 95 on the upper part of the image forming apparatus 1A.

In the second modification, the intermediate transfer belt 72 and respective rollers for driving the intermediate transfer belt 72 (i.e., the secondary transfer roller 75 and the secondary transfer backup roller 76) and the timing adjusting unit 5 of the above described embodiment are not provided.

In the second modification, the medium P stably transported by the medium transport apparatus 10 is fed into the image forming section 12, and therefore a positional displacement of an image or a jam of the recording medium P can be suppressed.

In this regard, the configuration of the image forming section is not limited to those described in the embodiment (FIG. 1) and the second modification (FIG. 14). For example, the image forming section may be configured to form an image using various methods (for example, inkjet method or the like) other than the electrophotographic method.

In the above described embodiment and modifications, configurations for transporting the continuous medium (for example, a rolled sheet) wound in a roll shape have been described. However, the present invention is applicable a configuration transporting an elongated medium such as a long sheet or the like.

Further, the present invention is not limited to a printer, but is also applicable to a facsimile machine, a copier, a MFP (Multi-Function Peripheral) or the like. Further, the present invention is also applicable to a document feeder used in an image reading apparatus.

While the preferred embodiments of the present invention have been illustrated in detail, it should be apparent that modifications and improvements may be made to the invention without departing from the spirit and scope of the invention as described in the following claims.

What is claimed is:

1. A medium transport apparatus comprising:
a transport section that transports a medium so that a widthwise direction of the medium is directed to a predetermined direction;
a contact roller that contacts the medium transported by the transport section, an axial direction of the contact roller being inclined with respect to the predetermined direction; and
a flange disposed at a side of the contact roller in the axial direction, the flange having a surface defining a position of the medium, the surface being perpendicular to the predetermined direction.

2. The medium transport apparatus according to claim 1, wherein the transport section includes a transport roller that transports the medium,
wherein the predetermined direction is an axial direction of the transport roller.

3. The medium transport apparatus according to claim 1, wherein the contact roller and the flange engage each other and rotate together with each other.

4. The medium transport apparatus according to claim 1, wherein the contact roller and the flange are formed integrally with each other.

5. The medium transport apparatus according to claim 1, wherein an inclination of the axial direction of the contact roller causes a force to be applied to the medium so that the medium is displaced to the side of the contact roller in the axial direction.

6. The medium transport apparatus according to claim 1, wherein the contact roller is supported by a support body swingable about a swing shaft parallel to the predetermined direction.

7. The medium transport apparatus according to claim 1, further comprising a transport guide disposed between the contact roller and the transport section, the transport guide guiding the medium and having a guide surface in the form of a curved surface.

8. The medium transport apparatus according to claim 1, wherein the medium is a continuous form,
the medium transport apparatus further comprising a medium holder that holds the medium wound in a roll shape,
wherein the contact roller is disposed between the medium holder and the transport section.

9. The medium transport apparatus according to claim 8, wherein the transport section includes a pair of rollers disposed so as to form a nip therebetween,
wherein the medium holder has a holding shaft holding the medium wound in the roll shape, and
wherein the contact roller is disposed below a plane passing through an uppermost portion of the holding shaft and the nip of the transport section.

10. The medium transport apparatus according to claim 8, wherein the medium holder includes a driving unit that applies a back tension to the medium in a direction opposite to the transport direction.

11. The medium transport apparatus according to claim 1, further comprising a cutting section disposed downstream of the transport section in a transport direction by the transport section, the cutting section being configured to cut the medium.

12. An image forming apparatus comprising:
the medium transport apparatus according to claim 1, and
an image forming section that forms an image on the medium transported by the medium transport apparatus.

13. The image forming apparatus according to claim 12, wherein the image forming section comprises:
an image forming unit that forms a developer image, and
a transfer unit that transfers the developer image formed by the image forming unit to the medium via an intermediate transfer body.

14. The image forming apparatus according to claim 12, wherein the image forming section comprises:
an image forming unit that forms a developer image, and
a transfer unit that transfers the developer image formed by the image forming unit directly to the medium.
